(19) United States
(12) Patent Application Publication
(10) Pub. No.: US 2017/0125019 A1
(43) Pub. Date: May 4, 2017

(54) AUTOMATICALLY ENABLING AUDIO-TO-TEXT CONVERSION FOR A USER DEVICE BASED ON DETECTED CONDITIONS

(71) Applicant: Verizon Patent and Licensing Inc., Arlington, VA (US)

(72) Inventors: Rajasundaram GANESAN, Chennai (IN); Prabhu V. Mohan, Chennai (IN); Vijay A. Senthil, Chennai (IN); Vinodkrishnan Surianarayanan, Chennai (IN); SriKamal X. Boyina, Visakhapatnam (IN); Vijaykanth Veeraiyan, Thanjavur (IN)

(21) Appl. No.: 14/924,980

(22) Filed: Oct. 28, 2015

(51) Int. Cl. G10L 15/26; H04M 1/64; H04W 64/00; H04W 4/12; H04W 4/02; H04M 1/725; H04W 4/16

(52) U.S. Cl. CPC G10L 15/26; H04M 1/72591; H04M 1/642; H04W 4/16; H04W 4/12; H04W 4/023; H04W 64/006

(57) ABSTRACT

A user device may detect one or more conditions associated with activating audio-to-text conversion for a call, and may determine that the one or more conditions are satisfied. The user device may activate audio-to-text conversion for the call between the user device and another device, and may receive an audio signal associated with the call. The user device may convert the audio signal to text, and may output the text for display via a display device associated with the user device.

### BACKGROUND

Audio-to-text conversion (e.g., closed captioning, speech-to-text conversion, etc.) enables an audio input to be transcribed and displayed as text on a display device. Audio-to-text conversion allows a viewer to understand information conveyed by an audio source when audio is unavailable or not easily understood.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of one or more devices of FIG. 2; and

FIG. 4 is a flow chart of an example process for automatically enabling audio-to-text conversion for a user device based on detected conditions.

### DETAILED DESCRIPTION OF PREFERRED EMBODIMENTS

The following detailed description of example implementations refers to the accompanying drawings. The same reference numbers in different drawings may identify the same or similar elements.

A user of a user device, such as a smart phone, may conduct calls (e.g., voice calls, video calls, etc.) on the user device in loud environments. In some instances, a noise level within the vicinity of the user may escalate, and the user may be unable to understand another participant on the call. As a result, the conversation may become strained, and the user may miss important information. Moreover, the user may have to terminate the call and resume the call at another time and/or at a different location. Implementations described herein may allow a user device to determine when to enable audio-to-text conversion during a call and to output an audio signal as text via a display of the user device, thereby allowing a user to more readily understand another participant on the call.

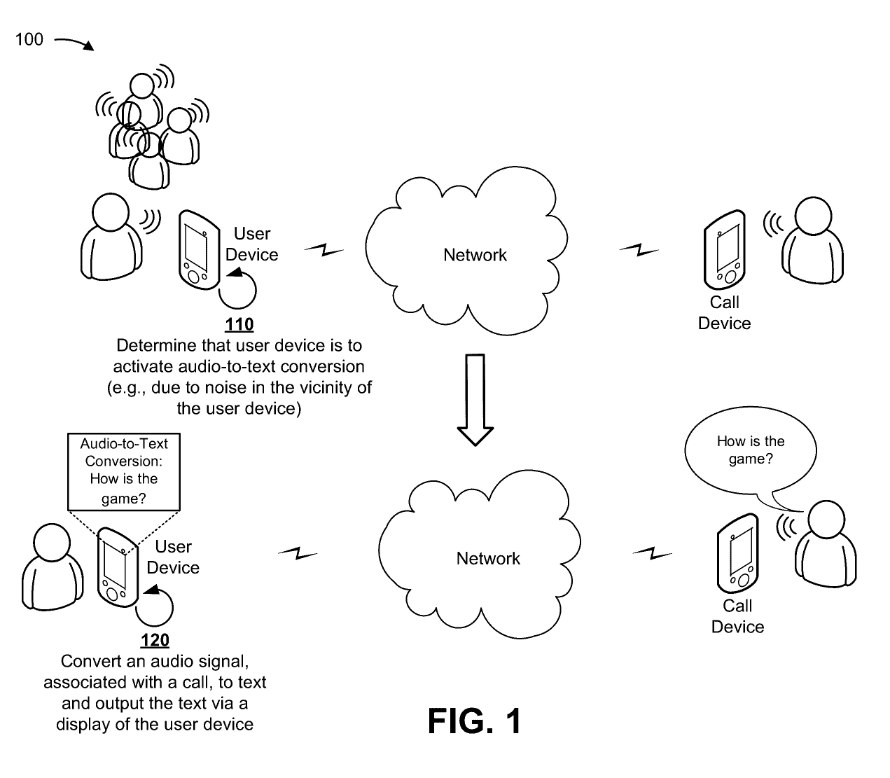

FIG. 1 is a diagram of an overview of an example implementation 100 described herein. As shown in FIG. 1, example implementation 100 may include a user device that may be connected on a call with a call device via a network. As shown by reference number 110, the user device may determine that the user device is to activate audio-to-text conversion. For example, the user device may detect one or more conditions using one or more sensors, and may determine that the one or more conditions are satisfied. In example implementation 100, assume that the user device uses a microphone to detect that a volume level within the vicinity of the user device exceeds a threshold volume level. As shown by reference number 120, the user device may convert an audio signal, associated with the call, to text, and may output the text via a display of the user device. For example, the user device may receive an audio signal from the call device, and may convert the audio signal to text. Further, the user device may display the text via a display of the user device. In this way, a conversation between a user of the user device and a user of the call device may be transcribed and displayed via a display of the user device.

Implementations described herein may allow a user device to determine when to enable audio-to-text conversion for a call. The user device may receive an audio signal associated with the call and may output text, corresponding to the audio signal, via a display of the user device. In this way, a user may more readily understand another participant on the call when the user is located in a loud environment and/or is in another situation where the user cannot readily hear the other participant. Further, implementations described herein may reduce the length of a call and/or an amount of calls needed to conduct a conversation, thereby conserving network resources. Further, by automatically determining when to enable audio-to-text conversion for a call, implementations described herein may reduce the need for manual user input in enabling audio-to-text conversion during a call. For example, the user device may automatically enable audio-to-text conversion, rather than requiring a user to manually navigate a user interface of the user device to enable audio-to-text conversion. In this way, the length of a call may be reduced, thereby conserving network resources.

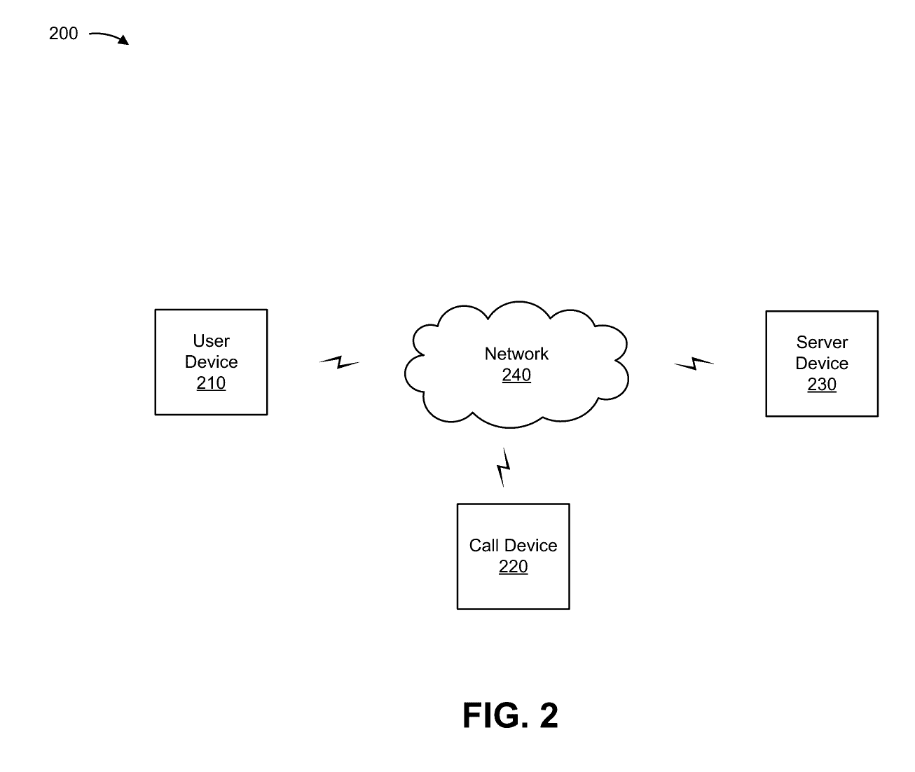

FIG. 2 is a diagram of an example environment 200 in which systems and/or methods, described herein, may be implemented. As shown in FIG. 2, environment 200 may include a user device 210, a call device 220, a server device 230, and a network 240. Devices of environment 200 may interconnect via wired connections, wireless connections, or a combination of wired and wireless connections.

User device 210 and/or call device 220 may include one or more devices capable of receiving, generating, storing, processing, and/or providing audio and/or video signals (e.g., signals including audio and/or video data). Further, user device 210 and/or call device 220 may include one or more devices capable of participating in a call (e.g., a voice call, a video call, etc.) with one or more other devices (e.g., via network 240). For example, user device 210 and/or call device 220 may include a communication device, such as a mobile phone capable of presenting information on a display (e.g., a smart phone, a radiotelephone, etc.), a laptop computer, a desktop computer, a tablet computer, a handheld computer, a wearable communication device (e.g., a smart wristwatch, a pair of smart eyeglasses, etc.), or a similar type of device. In some implementations, user device 210 may include one or more sensors (e.g., an accelerometer, a gyrometer, a temperature sensor, a photodiode, a global positioning system (GPS), a camera, a microphone, etc.) that permit user device 210 to receive input and/or detect conditions for activating audio-to-text conversion.

Server device 230 may include one or more devices capable of storing, processing, and/or routing information. In some implementations, server device 230 may receive an audio signal from user device 210 and/or call device 220, may convert the audio signal to text, and may provide the text (e.g., based on an audio-to-text conversion) to user device 210. In some implementations, server device 230 may provide information associated with audio-to-text conversion to user device 210 (e.g., conditions that cause user device 210 to activate and/or deactivate audio-to-text conversion, user preferences associated with audio-to-text conversion, etc.).

Network 240 may include one or more wired and/or wireless networks. For example, network 240 may include a cellular network (e.g., a long-term evolution (LTE) network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

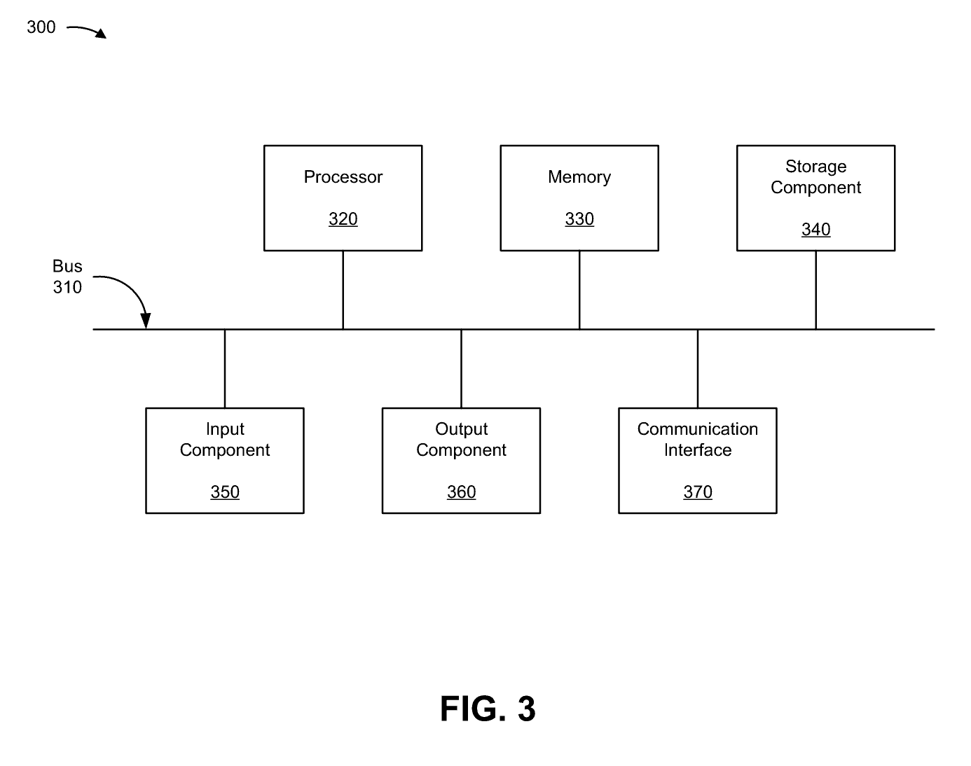

FIG. 3 is a diagram of example components of a device 300. Device 300 may correspond to user device 210, call device 220, and/or server device 230. In some implementations, user device 210, call device 220, and/or server device 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors capable of being programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, an infrared sensor, a light sensor, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

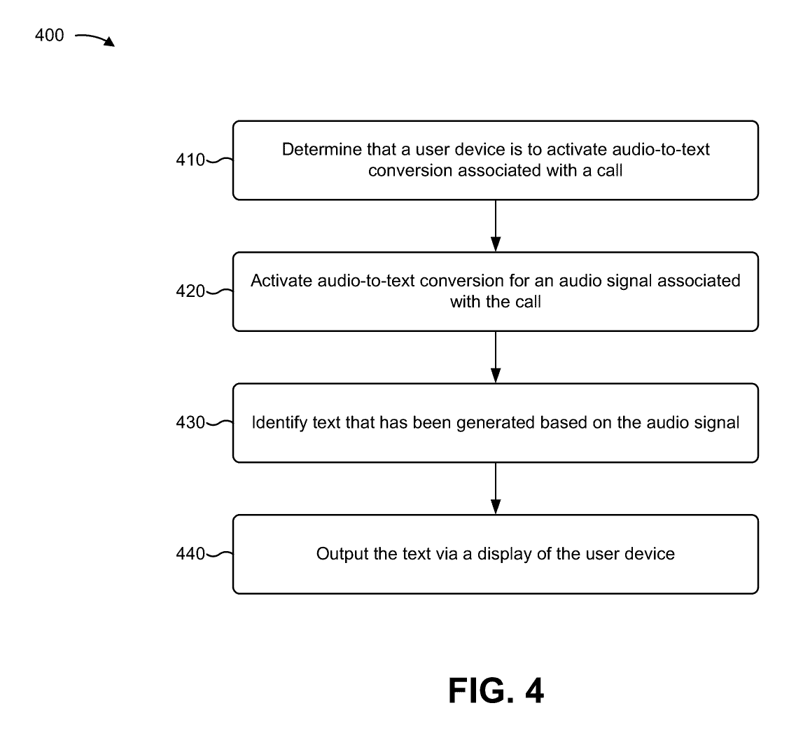

FIG. 4 is a flow chart of an example process 400 for automatically enabling audio-to-text conversion for a user device based on a detected condition. In some implementations, one or more process blocks of FIG. 4 may be performed by user device 210. In some implementations, one or more process blocks of FIG. 4 may be performed by another device or a group of devices separate from or including user device 210, such as call device 220 and/or server device 230.

As shown in FIG. 4, process 400 may include determining that a user device is to activate audio-to-text conversion associated with a call (block 410). For example, user device 210 may receive input (e.g., from a user of user device 210 and/or from another device, such as server device 230) indicating that user device 210 is to activate audio-to-text conversion. The audio-to-text conversion may include a technique to convert audio to text, such as a closed captioning technique, a speech-to-text conversion technique, or the like. In some implementations, a user may provide input to user device 210, and user device 210 may activate audio-to-text conversion based on receiving the input. Additionally, or alternatively, user device 210 may determine that user device 210 is to activate audio-to-text conversion based on determining that a condition is satisfied. For example, user device 210 may detect a condition, and may determine that user device 210 is to activate audio-to-text conversion based on the detected condition being satisfied. In some implementations, user device 210 may detect a condition by detecting that one or more parameters (e.g., sensed by user device 210) satisfy one or more thresholds.

In some implementations, the condition may be based on a volume level detected in the vicinity of user device 210. For example, user device 210 may use a microphone to determine a volume level of noise within the vicinity of user device 210. If the volume level satisfies a threshold (e.g., 90 dB), then user device 210 may activate audio-to-text conversion. Additionally, or alternatively, user device 210 may determine a frequency of the detected noise. If the frequency of the detected noise falls within a particular range (e.g., the frequency range of typical human voices, such as between 85 Hz and 255 Hz), and/or if the volume of noise within the particular frequency range satisfies a threshold (e.g., 90 dB), then user device 210 may activate audio-to-text conversion. In this way, when the user is in a noisy environment, user device 210 may enable audio-to-text conversion to assist the user with understanding what another participant is saying during a call.

In some implementations, the condition may be based on a detected movement of user device 210. For example, user device 210 may use an accelerometer, an infrared sensor, a light sensor, or the like, to determine a movement of user device 210 away from a user's head and/or ear, thus indicating that the user is viewing a display of user device 210. In some implementations, if user device 210 determines that user device 210 has moved away from the user's head and/or ear, then user device 210 may activate audio-to-text conversion. Additionally, or alternatively, if user device 210 determines that user device 210 has remained away from the user's head and/or ear for a threshold duration, then user device 210 may activate audio-to-text conversion. In this way, if the user is having difficulty understanding a conversation, then the user may move the phone (e.g., away from the user's head), and user device 210 may enable audio-to-text conversion to assist the user in understanding the other participant on the call.

In some implementations, the condition may be based on detecting a user's face (e.g., using facial recognition). For example, user device 210 may use a camera to detect the face of the user. User device 210 may detect the face of the user, which may be used to imply that the user is viewing a display of user device 210, and may activate audio-to-text conversion. In some implementations, user device 210 may detect the face of the user for a threshold amount of time, and may activate audio-to-text conversion. In some implementations, user device 210 may activate audio-to-text conversion based on detecting a movement of user device 210 away from a user's head and detecting a face of the user. In this way, if user device 210 determines that the user is viewing a display of user device 210, then user device 210 may enable audio-to-text conversion to assist the user in understanding a conversation. In some implementations, by enabling audio-to-text conversion based on detecting the face of the user for a threshold amount of time, user device 210 may prevent audio-to-text conversion from inadvertently being activated during instances where the user glances at the display (e.g., to check the time, etc.).

In some implementations, the condition may be based on a quantity of detected faces in the vicinity of user device 210 (e.g., using facial recognition). Additionally, or alternatively, the condition may be based on a quantity of detected faces in the vicinity of user device 210 satisfying a threshold. In this way, when the user is in a crowded environment, user device 210 may enable audio-to-text conversion to assist the user with understanding a conversation.

In some implementations, the condition may be based on a geographic location of user device 210. For example, user device 210 may use a GPS to determine a geographic location of user device 210. If user device 210 determines that user device 210 is located in a particular location (e.g., a venue associated with a particular level of noise, such as a stadium, an arena, a restaurant, a bar, a nightclub, etc.), then user device 210 may activate audio-to-text conversion. Additionally, or alternatively, the condition may be based on a change in geographic location of user device 210. In this way, when the user is in a typically noisy environment, user device 210 may enable audio-to-text conversion to assist the user in understanding a conversation. Further, if user device 210 determines that the user has travelled to a typically noisy environment, then user device 210 may enable audio-to-text conversion to assist the user in understanding a conversation.

In some implementations, the condition may be based on a time and/or date. For example, user device 210 may activate audio-to-text conversion based on a particular time (e.g., a time of the day, such as during a commute), a day of the week, and/or a day or month of the year, etc. Additionally, or alternatively, the condition may be based on a time and/or date and, for example, a geographic location. In this way, when the user is conducting a call during a particular time of day (e.g., during a commute) and/or at a particular venue, user device 210 may enable audio-to-text conversion to assist the user in understanding a conversation.

In some implementations, the condition may be based on a speed or velocity at which user device 210 is moving. For example, if user device 210 determines that user device 210 is moving at a threshold velocity (e.g., indicating that a user is travelling), then user device 210 may activate audio-to-text conversion. In this way, when the user is travelling (e.g., during a commute), user device 210 may enable audio-to-text conversion to assist the user in understanding a conversation.

In some implementations, user device 210 may determine that a user is operating a vehicle, and may disable audio-to-text conversion. For example, user device 210 may determine a particular connectivity (e.g., a Bluetooth connectivity associated with a vehicle), a geographic location of user device 210, an acceleration of user device 210, a velocity of user device 210, or the like, and may determine that a user is operating a vehicle. In this way, when the user is operating a vehicle, user device 210 may disable audio-to-text conversion (perhaps despite other conditions being satisfied).

In some implementations, the condition may be based on a quantity of other devices detected by user device 210. For example, user device 210 may detect other devices in the vicinity of user device 210 (e.g., by detecting near-field communication (NFC), available and/or connected radio communications, such as a Wi-Fi or Bluetooth connection, etc.), and may activate audio-to-text conversion based on the detected quantity of other devices satisfying a threshold. Additionally, or alternatively, the condition may be based on a network connectivity of user device 210, such as whether user device 210 is connected to a particular network (e.g., a Wi-Fi network with a particular name), or whether user device 210 detects a particular network within communicative proximity of user device 210. In this way, when the user is in the vicinity of a location associated with a particular noise level and/or crowdedness (e.g., a coffee shop, stadium, airport, etc.), user device 210 may enable audio-to-text conversion to assist the user in understanding a conversation.

In some implementations, the condition may be based on a signal quality value of an audio and/or video signal. For example, user device 210 may determine a signal quality value associated with a call (e.g., a voice call, video call, etc.). If the signal quality value satisfies a threshold value, then user device 210 may determine that user device 210 is to activate audio-to-text conversion associated with the call. User device 210 may determine that a signal quality value satisfies a threshold value, and may request another device (e.g., server device 230 and/or call device 220) to convert an audio signal to text, as described in more detail below. In this way, user device 210 may enable audio-to-text conversion to assist the user in understanding a conversation despite user device 210 receiving a low signal quality value.

In some implementations, user device 210 may activate audio-to-text conversion based on determining that a particular condition is satisfied. Additionally, or alternatively, user device 210 may activate audio-to-text conversion based on determining that multiple conditions are satisfied (e.g., based on a geographic location of user device 210 and a time of day). In some implementations, user device 210 may activate audio-to-text conversion based on a condition being satisfied for a threshold duration (e.g., user device 210 detecting a face of a user for a threshold duration). In some implementations, user device 210 may store information associated with audio-to-text conversion activation (e.g., specifying one or more conditions). Additionally, or alternatively, user device 210 may receive information, from another device (e.g., server device 230), associated with audio-to-text conversion activation.

In some implementations, user device 210 may provide a prompt for the user to activate audio-to-text conversion based on determining that a condition is satisfied. For example, the prompt may be a message displayed via a user interface of user device 210. User device 210 may determine that a condition is satisfied (e.g., a noise level satisfying a threshold), and may prompt the user to activate audio-to-text conversion. In this way, the user may prevent audio-to-text conversion from being enabled when the user is able to understand the conversation, does not want to activate audio-to-text conversion, or the like.

In some implementations, user device 210 may determine that user device 210 is to deactivate audio-to-text conversion. For example, a user may provide input to user device 210, and user device 210 may deactivate audio-to-text conversion based on receiving the input. Additionally, or alternatively, user device 210 may monitor one or more conditions, as described above, and may deactivate audio-to-text conversion based on one or more conditions no longer being satisfied. For example, user device 210 may determine that a condition that activated audio-to-text conversion is no longer satisfied (e.g., a noise level no longer satisfying a noise level threshold). Additionally, or alternatively, user device 210 may detect a condition to deactivate audio-to-text conversion, and may deactivate audio-to-text conversion based on the condition being met. For example, user device 210 may detect a proximity of user device 210 to a user's head (e.g., using a light sensor), and may deactivate audio-to-text conversion.

In some implementations, user device 210 may prevent audio-to-text conversion from deactivating once user device 210 activates audio-to-text conversion associated with a call. Alternatively, in some implementations, user device 210 may deactivate audio-to-text conversion during a call. In some implementations, user device 210 may prevent audio-to-text conversion from being deactivated for a threshold amount of time after audio-to-text conversion is activated. In this way, user device 210 may prevent an inadvertent deactivation of audio-to-text conversion.

In some implementations, user device 210 may activate audio-to-text conversion during a call. In some implementations, user device 210 may activate audio-to-text conversion when user device is not on a call, such as when user device 210 is providing audio and/or video content (e.g., when the user is listening to audio and/or video content). In some implementations, user device 210 may activate audio-to-text conversion based on a user preference (e.g., a condition, a threshold, etc.). For example, user device 210, and/or server device 230, may store information associated with a user preference (e.g., a condition, a threshold, etc. for enabling audio-to-text conversion).

In some implementations, user device 210 may disable audio-to-text conversion when user device 210 is connected to a peripheral device (e.g., a headset, an ear piece, a speaker, a microphone, etc.). For example, user device 210 may determine that a peripheral device is connected to user device 210 (e.g., via an auxiliary port, via Bluetooth, etc.), and may disable audio-to-text conversion. In this way, when the user is utilizing a peripheral device that assists the user with hearing another call participant (e.g., an ear piece), user device 210 may prevent audio-to-text conversion from activating (perhaps despite other conditions being satisfied) because the user may not need audio-to-text conversion to understand the call participant.

As further shown in FIG. 4, process 400 may include activating audio-to-text conversion for an audio signal associated with the call (block 420). For example, user device 210 may receive an audio signal associated with a call. The audio signal may include, for example, audio data received from call device 220 based on voice input provided to call device 220 (e.g., on a call with user device 210). Based on determining that user device 210 is to activate audio-to-text conversion and/or based on receiving an audio signal associated with a call, user device 210 may identify text that has been generated based on the audio signal, as described below.

In some implementations, user device 210 may transmit a prompt to call device 220 indicating that user device 210 is seeking permission to activate audio-to-text conversion (e.g., indicating that the conversation may be transcribed and recorded). In some implementations, user device 210 may enable audio-to-text conversion based on call device 220 permitting audio-to-text conversion of a call (e.g., granting permission).

As further shown in FIG. 4, process 400 may include identifying text that has been generated based on the audio signal (block 430). For example, the audio signal may be converted to text, and user device 210 may identify the text. In some implementations, user device 210 may receive an audio signal from call device 220 and may convert the audio signal to text using, for example, a speech-to-text converter. For example, call device 220 may receive a voice input, and may transmit an audio signal to user device 210 based on the voice input. User device 210 may receive the audio signal and may convert the audio signal to text based on receiving the audio signal from call device 220 and based on activating audio-to-text conversion.

In some implementations, user device 210 may transmit a message to call device 220 requesting call device 220 to convert a voice input to text. For example, if user device 210 determines that a signal quality value associated with an audio signal received from call device 220 satisfies a threshold value, then user device 210 may request call device 220 to convert a voice input to text. In some implementations, based on receiving the request from user device 210, call device 220 may display a prompt allowing a user of call device 220 to permit or deny the request from user device 210 for text conversion.

Additionally, or alternatively, user device 210 may transmit a message to server device 230 requesting server device 230 to convert an audio signal to text. In some implementations, audio signals may be routed from call device 220 to server device 230 based on user device 210 requesting server device 230 to convert audio signals to text. For example, call device 220 may transmit audio signals to server device 230, and server device 230 may provide text and/or audio signals to user device 210. Additionally, or alternatively, user device 210 may provide an audio signal to server device 230 after receiving and/or outputting the audio signal (e.g., to avoid a delay in a conversation). For example, server device 230 may convert audio signals received from call device 220 to text, and may provide the text to user device 210. In this way, call device 220 and/or server device 230 may generate the text, rather than user device 210 generating the text based on a poor audio signal.

In some implementations, call device 220 and/or server device 230 may provide text associated with an audio signal to user device 210. For example, call device 220 and/or server device 230 may provide text associated with an audio signal to user device 210, despite not receiving a message (e.g., a request) from user device 210. In this way, user device 210 may receive both the audio signal and text associated with the audio signal, and may display the text based on determining that a condition is satisfied, for example.

In some implementations, user device 210 may conduct a call with one or more call devices 220 (e.g., conduct a conference call). In such cases, user device 210 may receive audio signals from multiple call devices 220, and may convert the audio signals to text. Additionally, or alternatively, server device 230 may receive audio signals from one or more call devices 220 and may convert the audio signals to text. Further, one or more call devices 220 may convert an audio input (e.g., for a voice input provided directly to a particular call device 220) to text, and/or may convert received audio signals to text, in some implementations.

In some implementations, the text may include words spoken by a user of call device 220 (e.g., a voice input). Additionally, or alternatively, the text may include a paraphrase of words spoken by a user of call device 220, ambient noise captured by a microphone of call device 220, or the like. In some implementations, the text may include words associated with audio and/or video content being played by user device 210 (e.g., video media, audio media, etc.).

As further shown in FIG. 4, process 400 may include outputting the text via a display of the user device (block 440). For example, user device 210 may output the text via a display of user device 210. In some implementations, user device 210 may output the text for display via a display device associated with the user device. For example, user device 210 may be connected on a call (e.g., a voice call, a video call, etc.) with call device 220, and the display device may receive information associated with the call from user device 210 based on a particular connectivity. For example, the display device may be connected to user device 210 (e.g., wirelessly, via a wired connection, etc.). The display device may include, for example, a display screen (e.g., a touch screen), a monitor, or the like. In some implementations, user device 210 may output the audio signal via a speaker of user device 210 in addition to outputting the text via a display of user device 210. In some implementations, user device 210 may mute the audio signal based on outputting the text via a display of user device 210.

In some implementations, user device 210 may display the text for a threshold amount of time (e.g., a time value). Additionally, or alternatively, user device 210 may output the text for a particular amount of time based on identifying additional text (e.g., display new text as the new text becomes available and not display old text concurrently). In some implementations, a transcription of the entire conversation may be displayed via user device 210 (e.g., new text may be displayed by scrolling via the user display).

In some implementations, user device 210 may display the text via a display of user device 210, and may enable a user of user device 210 to input text. For example, user device 210 may receive a text input (e.g., from a user of user device 210), and may convert the text to an audio signal (e.g., using a text-to-speech converter). User device 210 may transmit the audio signal and/or the text to call device 220. In this way, user device 210 may enable a user of user device 210 to conduct a call using text based messaging.

In some implementations, user device 210 may save a transcription of a conversation associated with the call (e.g., the text). Additionally, or alternatively, user device 210 may transmit a transcription of the conversation to server device 230, call device 220, another device, an account (e.g., an email account) associated with user device 210, or the like. In some implementations, the transcript may include the text that was displayed via user device 210. In some implementations, the transcription may include text that was not displayed via user device 210. For example, the transcription may include text that was generated based on a voice input received by user device 210. For example, user device 210 may convert a voice input, received via a microphone of user device 210, to text and display the text via a display of user device 210. In this way, a complete transcription of the call may be saved via user device 210.

In this way, user device 210 may enable a user to maintain a call when the user is located in a loud environment and/or when the user cannot readily understand the other participant(s) on the call.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

Implementations described herein may enable a user device to activate audio-to-text conversion on the user device. In this way, the user device may display transcribed text associated with a call via a display of the user device, and may assist a user in maintaining a conversation when the user is located in a loud environment and/or when the user cannot readily hear another participant on the call. Further, implementations described herein may reduce the time and/or amount of calls needed to conduct a conversation, thereby conserving network resources.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store, or employ personal information provided by individuals, it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A user device, comprising:
one or more processors to:
determine whether a signal quality, detected by the user device and associated with a call, satisfies a threshold;
activate audio-to-text conversion for the call based on determining that the signal quality satisfies the threshold,
the call being between the user device and another device;
receive an audio signal associated with the call,
the audio signal being transmitted from the other device;
convert, after activating audio-to-text conversion for the call, the audio signal to text; and
output the text for display via a display device associated with the user device.

2. The user device of claim 1, where the one or more processors, when activating audio-to-text conversion for the call based on determining that the signal quality satisfies the threshold, are to:
automatically activate audio-to-text conversion without user input based on determining that the signal quality satisfies the threshold.

3. The user device of claim 1, where the threshold is a first threshold;
where the one or more processors are further to:
detect a volume level within a vicinity of the user device; and
determine that the volume level satisfies a second threshold; and
where the one or more processors, when activating audio-to-text conversion, are to:
activate audio-to-text conversion based on determining that the volume level satisfies the second threshold.

4. The user device of claim 1, where the one or more processors are further to:
detect a movement of the user device; and
determine that the movement satisfies the one or more conditions; and
where the one or more processors, when activating audio-to-text conversion, are to:
activate audio-to-text conversion based on determining that the movement satisfies the one or more conditions.

5. The user device of claim 1, where the one or more processors are further to:
provide the text for storage in an account associated with a user of the user device.

6. The user device of claim 1, where the one or more processors are further to:
determine a time of day; and
determine that the time of day satisfies one or more conditions; and
where the one or more processors, when activating audio-to-text conversion, are to:
activate audio-to-text conversion based on determining that the time of day satisfies the one or more conditions.

7. The user device of claim 1, where the one or more processors are further to:
determine that one or more conditions are no longer satisfied; and
deactivate audio-to-text conversion based on determining that the one or more conditions are no longer satisfied.

8. A non-transitory computer-readable medium storing instructions, the instructions comprising:
one or more instructions that, when executed by one or more processors of a user device, cause the one or more processors to:
determine whether a signal quality, detected by the user device and associated with a call, satisfies a threshold;
activate audio-to-text conversion for the call based on determining that the signal quality satisfies the threshold,
the call being between the user device and another device;
receive an audio signal associated with the call,
the audio signal being transmitted from the other device;
obtain, after activating audio-to-text conversion for the call, text based on the audio signal; and
output the text for display via a display device associated with the user device.

9. The non-transitory computer-readable medium of claim 8, where the one or more instructions, when executed by the one or more processors, further cause the one or more processors to:
convert the audio signal to the text; and
where the one or more instructions, that cause the one or more processors to obtain the text, cause the one or more processors to:
obtain the text based on converting the audio signal.

10. The non-transitory computer-readable medium of claim 8, where the one or more instructions, when executed by the one or more processors, further cause the one or more processors to:
transmit a message to another device requesting the other device to convert the audio signal to the text; and
receive the text from the other device; and
where the one or more instructions, that cause the one or more processors to obtain the text, cause the one or more processors to:
obtain the text based on receiving the text.

11. (canceled)

12. The non-transitory computer-readable medium of claim 8, where the one or more instructions, when executed by the one or more processors, further cause the one or more processors to:
detect a user input associated with activating audio-to-text conversion; and
determine that one or more conditions are satisfied based on detecting the user input.

13. The non-transitory computer-readable medium of claim 8, where the one or more instructions, when executed by the one or more processors, further cause the one or more processors to:
detect a face of a user; and
determine that one or more conditions are satisfied based on detecting the face of the user; and
where the one or more instructions, that cause the one or more processors to activate audio-to-text conversion, cause the one or more processors to:
activate audio-to-text conversion based on determining that the one or more conditions are satisfied.

14. The non-transitory computer-readable medium of claim 8, where the one or more instructions, further cause the one or more processors to:
present a prompt based on determining that one or more conditions are satisfied; and
receive a user input based on presenting the prompt; and
where the one or more instructions, that cause the one or more processors to activate audio-to-text conversion, cause the one or more processors to:
activate audio-to-text conversion based on receiving the user input.

15. A method, comprising:
determining, by a user device, whether a signal quality, detected by the user device and associated with a call, satisfies a threshold;
activating, by the user device, audio-to-text conversion based on determining that the signal quality satisfies the threshold;
receiving, by the user device, an audio signal;
obtaining, by the user device and after activating audio-to-text conversion, text based on the audio signal; and
outputting, by the user device, the text for display via a display device of the user device.

16. The method of claim 15, further comprising:
determining a network connectivity of the user device; and
determining that the network connectivity of the user device satisfies one or more conditions; and
where activating audio-to-text conversion comprises:
activating audio-to-text conversion based on determining that the network connectivity of the user device satisfies the one or more conditions.

17. The method of claim 15, further comprising:
determining that the user device is located in a particular geographic location; and
where activating audio-to-text conversion comprises:
activating audio-to-text conversion based on determining that the user device is located in the particular geographic location.

18. The method of claim 15, further comprising:
determining a velocity of the user device; and
determining that the velocity of the user device satisfies one or more conditions; and
where activating audio-to-text conversion comprises:
activating audio-to-text conversion based on determining that the velocity of the user device satisfies the one or more conditions.

19. The method of claim 15, further comprising:
transmitting a message to another device requesting the other device to convert the audio signal to the text; and
receiving the text from the other device; and
where obtaining the text comprises:
obtaining the text based on receiving the text from the other device.

20. The method of claim 15, where activating audio-to-text conversion based on determining that the signal quality satisfies the threshold comprises:
activating audio-to-text conversion without user input.

21. The non-transitory computer-readable medium of claim 8, where the one or more instructions, when executed by the one or more processors, further cause the one or more processors to:
determine that a vehicle is being operated; and
deactivate audio-to-text conversion based on determining that the vehicle is being activated.
